(19) United States
(12) Patent Application Publication
(10) Pub. No.: US 2011/0153088 A1
(43) Pub. Date: Jun. 23, 2011

(54) METHOD AND SYSTEM FOR CONTROLLING AND/OR REGULATING ROOM COMFORT VARIABLES IN A BUILDING

(75) Inventors: Markus GWERDER, Steinhausen (CH); Jürg Tödtli, Zurich (CH)

(73) Assignee: Siemens Aktiengesellschaft, Munich (DE)

(21) Appl. No.: 12/968,976

(22) Filed: Dec. 15, 2010

(30) Foreign Application Priority Data
Dec. 15, 2009 (EP) EP09179340

(51) Int. Cl. G05B 13/00; G05D 23/02

(52) U.S. Cl. 700/276; 700/275

(57) ABSTRACT

In a method for controlling and regulating at least one room comfort variable (T_{R1}; T_{R2}) in a building, requirement signals (30) for cost-intensive energy are stored during a time interval (73) comprising a specified time period, the requirement signals (30) stored in the elapsed time interval are evaluated and used to generate current control signals (10, 11 . . . 15) for actuators for the use of what is known as free or low-cost energy. The method minimizes the consumption of cost-intensive or what is known as not free energy whilst still satisfying a predefined comfort requirement when heating, cooling, ventilating, lighting and shading rooms or zones of rooms in the building.

### CROSS REFERENCE TO RELATED APPLICATIONS

This application claims the benefit of European Application No. 09179340, filed on Dec. 15, 2009, which is hereby incorporated by reference herein.

### BACKGROUND

1. Field

The embodiments relate to a method and system for controlling and regulating at least one room comfort variable in a building.

2. Description of the Related Art

A method is known from WO2007/042371 A, in which it is proposed that a model predictive facility be employed to control the use of a low-cost energy source.

Such methods are suitable, for example, for heating, cooling, ventilating, lighting and shading rooms or zones of rooms in buildings and are, for example, implemented in a building automation system.

Methods and systems for controlling and/or regulating room comfort variables in a building are generally known.

Suitable energy is required to heat, cool, ventilate and light a building. The costs of such energy are incurred, on the one hand, directly for purchasing, processing or storing purposes and, on the other hand, when eliminating or compensating for secondary effects. Such energy costs are generally time-dependent. It is thus possible, for example, to purchase a fuel relatively cheaply at a certain time. However during the combustion of a fuel gases and particles may be produced, which incur, for example, taxes or duties to the state or have to be filtered at cost, so that such a fuel generally is not a low-cost form of energy for heating purposes.

In the present text free energy refers to a low-cost energy source, which in the time segment in question is relatively cheap compared with other suitable and available energy sources—so not necessarily literally completely free. In contrast, an energy source is referred to as not free or as cost-intensive here if in the time segment in question it is relatively expensive compared with other suitable energy sources. Solar heat radiating in through windows or the shell of the building and sunlight radiating in through windows are typically free energies, while heat generated using heating oil or cold generated using electricity are cost-intensive energies or not free. Essentially an energy source based to a large extent on primary energy is cost-intensive. However cost-intensive energy can also mean that the consumption of the relevant energy incurs higher costs, in other words is less economical.

### SUMMARY

The embodiments include a method, by which the consumption of cost-intensive or what is known as not free energy can be minimized whilst still satisfying a predefined comfort requirement when heating, cooling, ventilating, lighting and shading rooms or zones of rooms in buildings. An system with which the method can be implemented is also specified.

Exemplary embodiments are described in more detail below with the aid of drawings

### BRIEF DESCRIPTION OF THE DRAWINGS

These and other aspects and advantages will become more apparent and more readily appreciated from the following description of the exemplary embodiments, taken in conjunction with the accompanying drawings of which:

FIG. 1 shows a system for controlling and/or regulating room comfort variables in a building,

FIG. 2 shows a schematic diagram of a room having devices for integrated room automation,

FIG. 3 shows an exemplary temporal profile of the measured temperature in the room,

FIG. 4 shows exemplary rules for determining operating states for adjusting venetian blinds,

FIG. 5 shows exemplary rules for determining operating states for controlling free cooling,

FIG. 6 shows exemplary rules for determining operating states for controlling free/natural ventilation during the night,

FIG. 7 shows exemplary rules for determining operating states for controlling mechanical ventilation during the night, and

FIG. 8 shows exemplary rules for determining operating states for controlling an energy recovery facility.

### DETAILED DESCRIPTION OF THE PREFERRED EMBODIMENT

Reference will now be made in detail to the preferred embodiments, examples of which are illustrated in the accompanying drawings, wherein like reference numerals refer to like elements throughout.

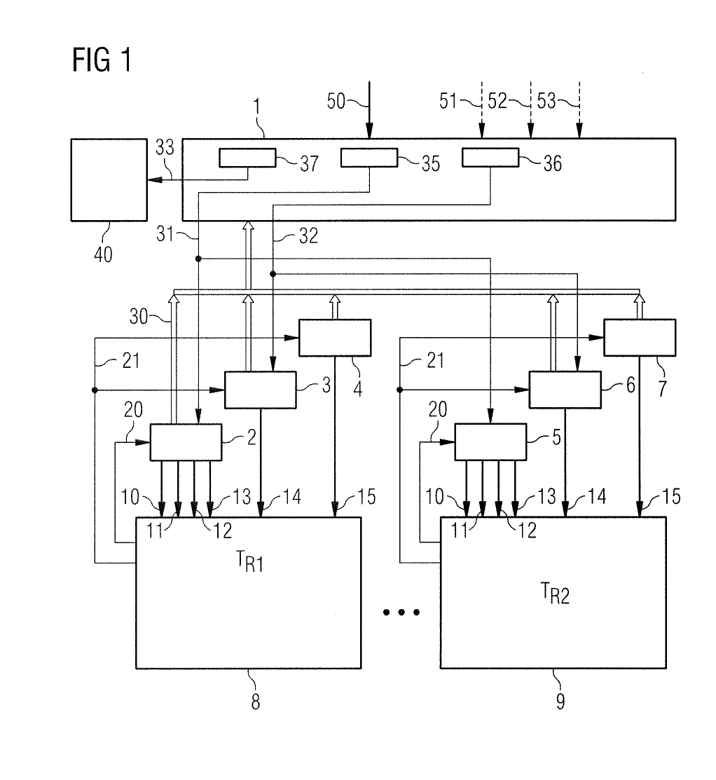

In FIG. 1 the reference character 1 designates a control facility, such as a processor, disposed at an upper hierarchical level for the optimizable control of the use of at least one low-cost or free energy source. Facilities 2, 3, 4, 5, 6 and 7 are disposed at a lower hierarchical level below the upper hierarchical level for the lower-order regulation and/or control of further energy sources.

A system featuring the two hierarchical levels allows the control and regulation of room comfort variables in a building. The building typically features a plurality of rooms 8 and 9.

A first facility 2 and a second facility 5 of the lower hierarchical level control and/or regulate room air conditioning variables in the rooms 8 and 9. The controlled and/or regulated room air conditioning variables are typically at least room temperature T_{R1}, and/or T_{R2} of the rooms 8 and/or 9 and if required further variables reflecting the state of the air in the room 8 or 9, for example, the humidity, carbon dioxide content or proportion of volatile organic compounds (VOC). It is evident that the rooms 8 and 9 can generally not only be closed individual rooms but also zones of rooms.

A third facility 3 and a fourth facility 6 of the lower hierarchical level control and/or regulate the position or radiation permeability of the shading facilities acting at windows of the room 8 and/or 9. The shading facility can be realized for example by venetian blinds, roller shutters, blinds or vertical blinds. A further variant for realizing the shading facility would be to use windows with electrically controlled shading or with integrated electrically controlled micro-mirrors.

A fifth facility 4 and a sixth facility 7 of the lower hierarchical level control and/or regulate the brightness of lighting units disposed in the room 8 and/or 9.

The workings of the heating, cooling, ventilation, lighting and shading systems that can be used to control and/or regulate the room comfort variables in the rooms 8 and 9 are therefore operated by the regulation and/or control facilities 2, 3, 4, 5, 6 and 7 disposed at the lower hierarchical level.

The term working here includes essentially all the devices, installations and features of the energy circuits for heating, cooling, ventilating and lighting that are present or can be employed to achieve a desired room comfort.

Output signals of the regulation and/or control facilities 2, 3, 4, 5, 6 and 7 for controlling and/or regulating the workings for the rooms 8 and 9 are symbolized by arrows 10, 11, 12, 13, 14 and 15 in FIG. 1. The rooms 8 and 9 for example have heating 10, cooling 11, free cooling 12 and ventilating 13 controlled by first regulation and/or control facilities 2 and/or 5, sun protection 14 controlled by second regulation and/or control facilities 3 and/or 6 and lighting 15 controlled by third regulation and/or control facilities.

The room comfort variables of the rooms 8 and 9 required for control and/or regulation purposes are captured by corresponding sensors and their measured variables are fed back to the assigned regulation and/or control facilities 2, 3, 4, 5, 6 and 7. A first measured variable 20 of room temperature T_{R1} and/or T_{R2} is fed back to the assigned regulation and/or control facility 2 and/or 5 by way of example in FIG. 1. 21 designates further measured variables of room comfort variables fed back by way of example to the corresponding regulation and/or control facilities 3, 4, 6 and 7.

30 designates a data flow from the lower hierarchical level to the control facility 1. The data flow 30 includes all the information from the lower hierarchical level required in the control facility 1, i.e. at the upper hierarchical level, to generate reference signals 31, 32 and 33 that can be used at the lower hierarchical level. According to the embodiments the data flow 30 includes requirement signals for cost-intensive energy, in particular for heating and cooling. However the data flow 30 also advantageously includes measured values of the room comfort variables captured in the rooms 8 and 9 as well as setpoint values of room comfort variables and information about room occupancy or use. The requirement signals for cost-intensive energy for heating, cooling, ventilating or lighting are generated by the regulation and/or control facilities 2, 3, 4, 5, 6, and 7 disposed at the lower hierarchical level.

In one advantageous embodiment of the first regulation and/or control facility 2 and also of the second regulation and/or control facility 5 a heating and cooling requirement of an assigned heating and/or cooling unit is calculated and mapped onto at least one corresponding variable, which is advantageously transmitted according to a known standard, for example according to Konnex or BACnet, at least as part of the data flow 30 to the control unit 1. The calculated heating and cooling requirement is also the basis for generating the outputs signals for heating 10, cooling 11, free cooling 12 and ventilating 13.

In one advantageous embodiment of the third regulation and/or control facility 3 and also of the fourth regulation and/or control facility 6 a requirement for sun protection or shading is calculated and mapped onto a corresponding variable, which is advantageously transmitted according to a known standard, for example according to Konnex or BACnet, at least as part of the data flow 30 to the control unit 1. The calculated requirement for sun protection is also the basis for generating the output signal for sun protection 14.

One advantageous implementation of the reference signals 31, 32 and 33 is achieved by the definition of at least one operation type or even a number of operation types for free and low-cost energies that can be used in the building. An operation type advantageously comprises a certain number of operating states in each instance, a certain operation type essentially being able to feature quite a number of operating states at a certain time point.

A first operation type 35 generated by the control facility 1 includes for example, the operating states “free-cooling”, “natural-ventilation-night” and “mechanical-ventilation-night”, it being possible to set each operating state for its part to operating state values “charge-storage-unit” or “discharge-storage-unit”.

Based on a notation for data structures commonly used in computer programs, a notation related to the associated operating state, in which the operating state value is connected by a period to the respective operating state, in other words for example “free-cooling.charge-storage-unit” or “natural-ventilation-night.discharge-storage-unit” or generally “operating-state.operating-state-value” is used in the following for a specific operating state value that is stored as a variable in a memory such as in a computer.

A second operation type 36 generated by the control facility 1, for example, includes the operating state “venetian-blind-position” or “vertical-blind-position” with operating state values “fixed-in-position”, “charge-storage-unit” or “discharge-storage-unit”; if required the operating state value “fixed-in-position” also includes a value for the degree of opening or a value relating to the vertical blind position.

A third operation type 37 generated by the control facility 1 to operate an air processing unit 40 includes for example, the operating state “heat-recovery” with operating state values “charge-storage-unit” and “discharge-storage-unit”.

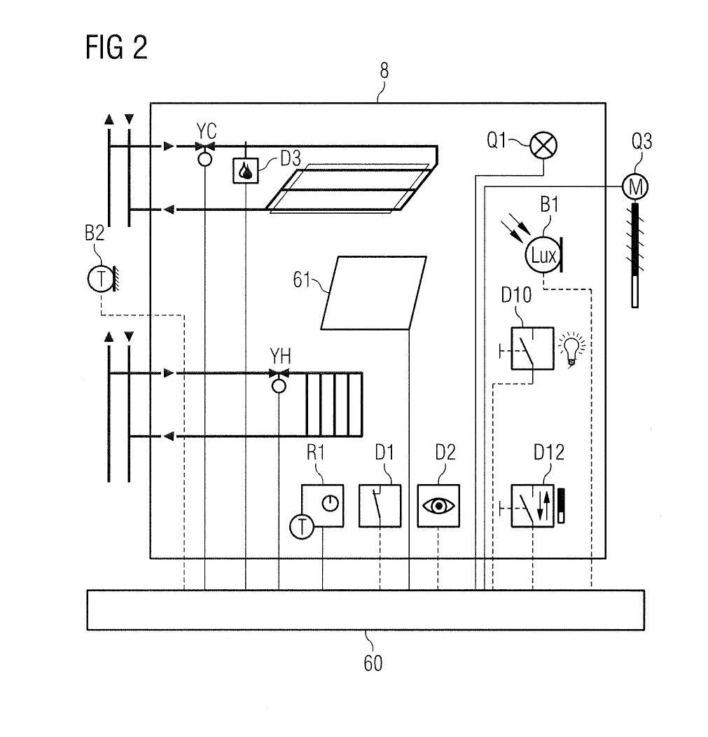

It is evident that specific names and quantities introduced here for the concept described above based on operation type or operation types and operating state and operating state value also represent a meaningful option in relation to the examples illustrated in FIGS. 1 and 2. It is possible to introduce just one operation type or a plurality of operation types depending on the requirement. The number of operating states of each introduced operation type and also the number of operating state values of a respective operating state can also be tailored without further ado to the workings to be operated.

In one advantageous exemplary embodiment, each operation type 35, 36, 37 is implemented respectively by a structured variable which also realizes the corresponding reference signal 31, 32 or 33, for example. Essentially information about the operation types 35, 36 and 37 is forwarded as reference signals 31, 32 and 33 to the facilities for lower-order regulation and/or control 2, 3, 4, 5, 6, 7 or to the air processing unit 40.

In further developments of the control unit 1, the control unit 1 has further data inputs, advantageously a further data input 50 for predicting weather and/or building occupancy, a further data input 51 for information relating to the radiation intensity of the sun, a further data input 52 for the outside temperature and a further data input 53 for the temperature of a low-cost cooling energy source.

The purpose of optimization when controlling and/or regulating room comfort variables in a building is to achieve a predefined level of comfort in respect of room temperature, brightness and air quality—in other words for example humidity, carbon dioxide content and proportion of volatile organic compounds—at the lowest possible cost. It is therefore necessary when heating, cooling, ventilating, lighting and shading rooms or zones of rooms in the building to minimize consumption of cost-intensive or what is known as not free energy, whilst still satisfying comfort requirements. Optimization over a certain time period takes place in respect of the greatest possible coverage of the energy required for heating, cooling, ventilating and lighting by free energy. To achieve the optimization, the attribute of the building as a thermal storage unit in particular is also utilized. With low-cost workings the consumption of cost-intensive workings is also advantageously reduced, even if there is currently no requirement for cost-intensive workings. In one advantageous variant, this can also be achieved prospectively, for example, by utilizing weather or room occupancy forecasts. Requirement signals recorded in the past are also advantageously used for optimization, it being assumed for example that the requirement will continue to be roughly identical in the near future. Simulations have shown that such a persistency forecast is in many instances sufficient to achieve significant savings.

Recorded requirement signals of workings operated in a cost-intensive manner are advantageously evaluated using additional variables such as actual values and setpoint values of room comfort variables and/or weather and room occupancy forecasts, in order to be able to control and/or regulate the workings operated at low cost. Operation types are advantageously defined which are determined by rules based on recorded requirement signals and additional variables. The operation types are advantageously defined in such a manner that they can each include a valid number of values, so that the number of values for example results in a forecast relating to venetian blind position, free cooling and night ventilation. The operation types determined by the rules in turn define clearly defined actions for workings operated at low cost.

A function unit, such as microcontroller, designated as 60 in FIG. 2 includes the control facility 1 (FIG. 1) and the facilities 2, 3 and 4 for lower-order regulation and/or control connected to the control unit 1 by way of data communication channels. The function unit 60 regulates and/or controls the room comfort variables provided for in the room 8 in an optimized manner in respect of a predefined purpose.

The example of integrated room automation illustrated in FIG. 2 only includes a minimum of workings to illustrate the principle of the embodiments. The described method for optimized control and regulation of room comfort variables can essentially be applied without further ado, even if more or fewer workings or if other workings that can be operated cost-intensively or at low cost are employed.

The devices disposed by way of example in the room 8 are a room device R1 featuring a temperature sensor, a daylight sensor B1 for measuring light intensity, a window switch D1, a presence sensor D2, an operating unit D12, such as a mechanical actuator, for the indirect operation of venetian blinds or venetian blind drive units Q3, a further operating unit D10 for the indirect operation of light units Q1, a heating valve YH of a heating circuit that can be controlled by the function unit 60 and a cooling valve YC that can be controlled by the function unit 60 as well as a dew point sensor D3 of a cooling circuit. An outside temperature sensor B2 is disposed outside the building. The workings are connected to the function unit 60 by way of data communication channels. The data communication channels are realized wirelessly or wired in the known manner. If necessary workings can also be supplied with electricity by way of the function unit 60. The cooling circuit here comprises a cooling ceiling that can be operated for at least some of the time with free energy—for example by a cooling tower.

In one advantageous variant of the function unit 60, at least one operation type 35, 36 or 37 predefined by the control unit 1 (FIG. 1) can be explained on a display unit 61 in the room 8. The display unit 61 is, for example, a device disposed in the room for just this purpose or a window that can be generated on a screen of a personal computer. The display unit 61 helps the inhabitants or users of the room 8 to achieve a greater acceptance in respect of current values of room comfort variables or, for example, the position of venetian blinds or the activity of a ventilation system used.

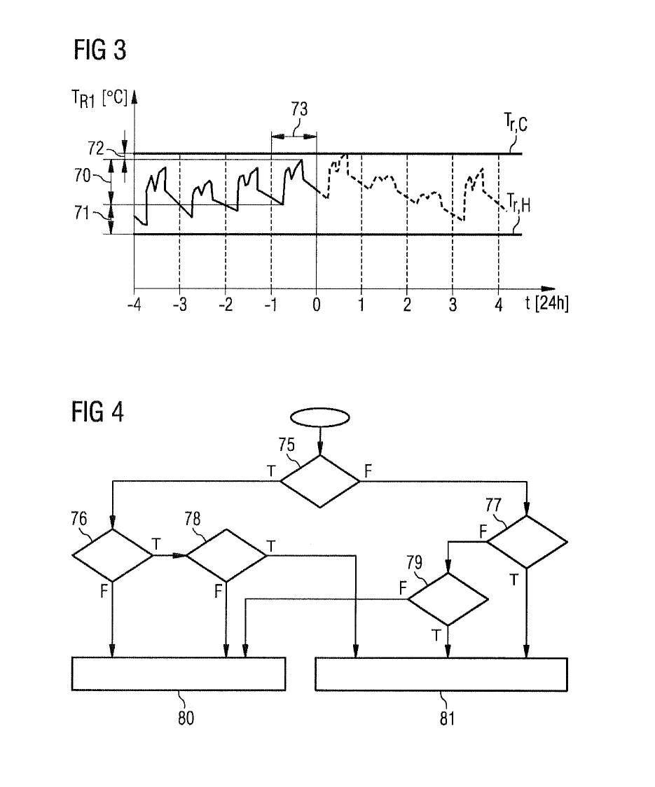

The time-dependent profile of the room temperature T_{R1} or T_{R2} in one of the rooms 8 or 9 is illustrated as an example of a time-dependent profile of a room comfort variable in FIG. 3. The room temperature T_{R1} progresses in a temperature comfort band bounded by an adjustable lower setpoint temperature value T_{r,H} and an adjustable upper setpoint temperature value T_{r,C}, as sought by the function unit 60 (FIG. 2). A time axis t is divided into days of 24 hours, the present or a current time point being designated as 0. A first temperature difference 70 shows the difference in room temperature T_{R1} during a certain just elapsed time interval 73. A advantageously constant time period of the time interval 73 is important for an analysis and evaluation of requirement signals active in the past for cost-intensive energy for heating, cooling, ventilating or lighting, these having been generated at the lower hierarchical level by the regulation and/or control facilities 2, 3, 4, 5, 6, or 7 (FIG. 1). The time period of the time interval 73 here is for example a day or twenty-four hours. If the time interval 73 is set at around 24 hours, experience shows that good conditions result for the calculation and generation of current control signals for corresponding actuators for the use of what is known as free or low-cost energy. In principle the time period can also be set as shorter or longer than a day. An advantageous time interval 73 results with a time period between around six hours and three days.

A second temperature difference 71 designates a minimum difference Δ∂_{r,H} between the room temperature T_{R1} and the lower setpoint temperature value T_{r,H} determined in the just elapsed time interval 73. The difference Δ∂_{r,H} becomes negative if the room temperature T_{R1} reaches a value below the lower setpoint temperature value T_{r,H} in the time interval 73.

A third temperature difference 72 designates a minimum difference Δ∂_{r,C} between the room temperature T_{R1} and the upper setpoint temperature value T_{r,C} determined in the just elapsed time interval 73. The difference Δ∂_{r,C} becomes negative if the room temperature T_{R1} reaches a value above the upper setpoint temperature value T_{r,H} in the time interval 73.

The control facility 1 (FIG. 1) automatically determines and stores at least one operation type 35, 36 or 37, with requirement signals stored in an elapsed time interval 73 being evaluated to determine the operation type, its operating states and operating state values and set operation types being used to generate current control signals for actuators for the use of what is known as free or low-cost energy.

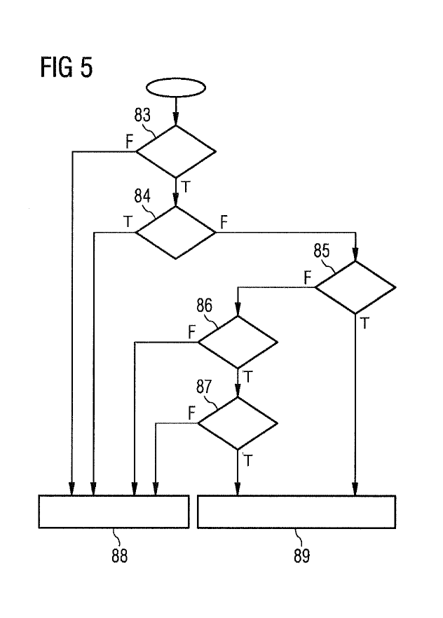

FIG. 4 shows a flow diagram to illustrate, for example, rules executed by a controller, such as a microcontroller, according to which operating state values of the operating state “venetian-blind-position” of the second operation type 36 (FIG. 1) are defined and set for corresponding control of the venetian blinds.

In a first decision 75 the Boolean expression “heating requirement determined in the time interval 73” is evaluated and if the expression is true, the method continues with a second decision 76, or otherwise with a third decision 77. In flow diagrams used here decisions each have two possible outcomes: an outcome shown as “T” if the corresponding Boolean expression is true and an outcome shown as “F” if the Boolean expression is false. In the second decision 76 the Boolean expression “cooling requirement determined in the time interval 73” is evaluated and if the expression is true, the method continues with a fourth decision 78, otherwise in a first step 80 the operating state “venetian-blind-position” is set to the operating state value “charge-storage-unit”. In the fourth decision 78 the Boolean expression “the last action was heating” is evaluated and if the expression is true, in a second step 81 the operating state “venetian-blind-position” is set to the operating state value “discharge-storage-unit”, otherwise the first step 80 is performed, in which the operating state “venetian-blind-position” is set to the operating state value “charge-storage-unit”. In the third decision 77 the Boolean expression “cooling requirement determined in the time interval 73” is evaluated and if the expression is true, the second step 81 is performed, in which the operating state “venetian-blind-position” is set to the operating state value “discharge-storage-unit”, otherwise the method continues with a fifth decision 79. In the fifth decision 79 the Boolean expression “the room temperature is high” is evaluated and if the expression is true, the second step 81 is performed, in which the operating state “venetian-blind-position” is set to the operating state value “discharge-storage-unit”, otherwise the first step 80 is performed, in which the operating state “venetian-blind-position” is set to the operating state value “charge-storage-unit”. An advantageous specific instance of the Boolean expression “the room temperature is high” is obtained by a comparison of the second temperature difference 71 (FIG. 3) with the third temperature difference 72, in other words by the Boolean expression Δ∂_{r,H}≧Δ∂_{r,C.}

The output signal sun protection 14 is generated in the third facility 3 responsible for operating the shading facility in the room 8 as a function of the reference signal 32 which corresponds to the set operating state value of the operating state “venetian-blind-position”. If “venetian-blind-position.charge-storage-unit” is set, the venetian blinds are advantageously fully closed at night and fully open during the day. However if “venetian-blind-position.discharge-storage-unit” is set, the venetian blinds are fully open at night and during the day, if the room 8 is occupied, the position of the venetian blinds is regulated to a lower setpoint value of light intensity. However in the unoccupied room 8 the venetian blinds are fully closed all day if “venetian-blind-position.discharge-storage-unit” is set.

The reference signal 32 therefore allows automatic energy-efficient operation of the workings. In a further variant of the method for controlling and/or regulating room comfort variables a room user is allowed manually to override certain actuators influenced by reference signals generated in the control facility 1. The room user is thus allowed to override the automatically reached venetian blind position manually at the cost of energy efficiency for example.

FIG. 5 shows a flow diagram to illustrate, by way of example, rules also executed by a controller, according to which operating state values of the operating states “free-cooling” of the first operation type 35 (FIG. 1) are defined and set for the corresponding control or regulation of a facility for cooling using free energy.

In a sixth decision 83 the Boolean expression “the room is occupied and it is night” is evaluated and if the expression is true, the method continues with a seventh decision 84, otherwise in a third step 88 the operating state “free-cooling” is set to the operating state value “charge-storage-unit”. In the seventh decision 84 the Boolean expression “heating requirement determined in the time interval 73” is evaluated and if the expression is true, the third step 88 is performed, in which the operating state “free-cooling” is set to the operating state value “charge-storage-unit”, otherwise the method continues with an eighth decision 85. In the eighth decision 85 the Boolean expression “cooling requirement determined in the time interval 73 and no free cooling” is evaluated and if the expression is true, a fourth step 89 is performed, in which the operating state “free-cooling” is set to the operating state value “discharge-storage-unit”, otherwise the method continues with a ninth decision 86. In the ninth decision 86 the Boolean expression “the room temperature is high” is evaluated and if the expression is true, the method continues with a tenth decision 87, otherwise in the third step 88 the operating state “free-cooling” is set to the operating state value “charge-storage-unit”. An advantageous specific instance of the Boolean expression “the room temperature is high” is obtained by a comparison of the second temperature difference 71 (FIG. 3) with the third temperature difference 72, in other words by the Boolean expression Δ∂_{r,H}≧Δ∂_{r,C}. In the tenth decision 87 the Boolean expression “the room temperature possibly exceeds the upper setpoint temperature value” is evaluated and if the expression is true, the fourth step 89 is performed, in which the operating state “free-cooling” is set to the operating state value “discharge-storage-unit”, otherwise the third step 88 is performed, in which the operating state “free-cooling” is set to the operating state value “charge-storage-unit”.

The output signal free cooling 12 is generated in the first facility 2 responsible for operating the free cooling in the room 8 as a function of the reference signal 31 which corresponds to the set operating state value of the operating state “free-cooling”. If “free-cooling.charge-storage-unit” is set, free cooling is advantageously not activated, otherwise free cooling is activated if the thermal mass of the building can be discharged by free cooling due to prevailing temperature conditions.

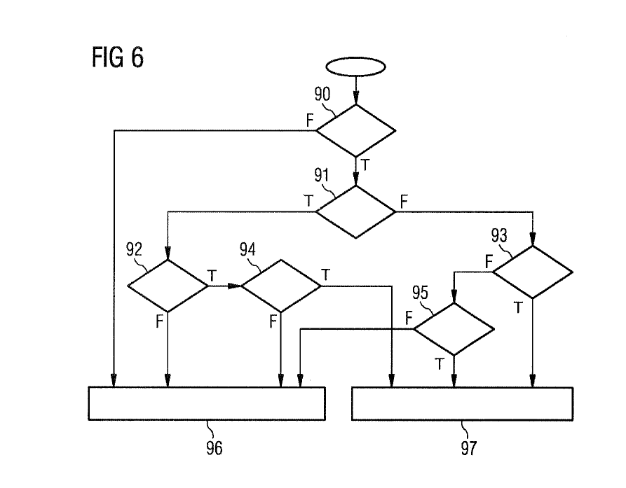

FIG. 6 shows a flow diagram to illustrate, for example, rules also executed by a controller, according to which operating state values of the operating state “natural-ventilation-night” of the first operation type 35 (FIG. 1) are defined and set for corresponding control of the venetian blinds.

In an eleventh decision 90 the Boolean expression “the room is occupied and it is night” is evaluated and if the expression is true, the method continues with a twelfth decision 91, otherwise in a fifth step 96 the operating state “natural-ventilation-night” is set to the operating state value “charge-storage-unit”. In the twelfth decision 91 the Boolean expression “heating requirement determined in the time interval 73” is evaluated and if the expression is true, the method continues with a thirteenth decision 92, or otherwise with a fourteenth decision 93. In the thirteenth decision 92 the Boolean expression “cooling requirement determined in the time interval 73” is evaluated and if the expression is true, the method continues with a fifteenth decision 94, otherwise in the fifth step 96 the operating state “natural-ventilation-night” is set to the operating state value “charge-storage-unit”. In the fifteenth decision 94 the Boolean expression “the last action was heating” is evaluated and if the expression is true, in a sixth step 97 the operating state “natural-ventilation-night” is set to the operating state value “discharge-storage-unit”, otherwise the fifth step 96 is performed, in which the operating state “natural-ventilation-night” is set to the operating state value “charge-storage-unit”. In the fourteenth decision 93 the Boolean expression “cooling requirement determined in the time interval 73” is evaluated and if the expression is true, the sixth step 97 is performed, in which the operating state “natural-ventilation-night” is set to the operating state value “discharge-storage-unit”, otherwise the method continues with a sixteenth decision 95. In the sixteenth decision 95 the Boolean expression “the room temperature is high” is evaluated and if the expression is true, the sixth step 97 is performed, in which the operating state “natural-ventilation-night” is set to the operating state value “discharge-storage-unit”, otherwise the fifth step 96 is performed, in which the operating state “natural-ventilation-night” is set to the operating state value “charge-storage-unit”. An advantageous specific instance of the Boolean expression “the room temperature is high” is obtained by a comparison of the second temperature difference 71 (FIG. 3) with the third temperature difference 72, in other words by the Boolean expression Δ∂_{r,H}≧Δ∂_{r,C.}

The output signal ventilate 13 is generated in the first facility 2 responsible for operating the natural ventilation in the room 8 as a function of the reference signal 31 which corresponds to the set operating state value of the operating state “natural-ventilation-night”.

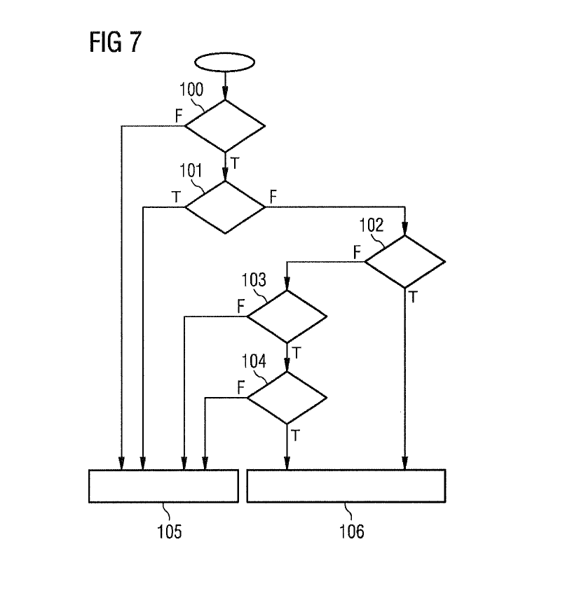

FIG. 7 shows a flow diagram to illustrate, for example, rules also executed by a controller, according to which operating state values of the operating state “mechanical-ventilation-night”of the first operation type 35 (FIG. 1) are defined and set for corresponding control or regulation of a mechanical ventilation facility using low-cost energy.

In a seventeenth decision 100 the Boolean expression “the room is occupied and it is night” is evaluated and if the expression is true, the method continues with an eighteenth decision 101, otherwise in a seventh step 105 the operating state “mechanical-ventilation-night” is set to the operating state value “charge-storage-unit”. In the eighteenth decision 101 the Boolean expression “heating requirement determined in the time interval 73” is evaluated and if the expression is true, the seventh step 105 is performed, in which the operating state “mechanical-ventilation-night” is set to the operating state value “charge-storage-unit”, otherwise the method continues with a nineteenth decision 102. In the nineteenth decision 102 the Boolean expression “cooling requirement determined in the time interval 73 and no free cooling” is evaluated and if the expression is true, an eighth step 106 is performed, in which the operating state “mechanical-ventilation-night” is set to the operating state value “discharge-storage-unit”, otherwise the method continues with a twentieth decision 103. In the twentieth decision 103 the Boolean expression “the room temperature is high” is evaluated and if the expression is true, the method continues with a twenty-first decision 104, otherwise in the seventh step 112 the operating state “mechanical-ventilation-night” is set to the operating state value “charge-storage-unit”. An advantageous specific instance of the Boolean expression “the room temperature is high” is obtained by a comparison of the second temperature difference 71 (FIG. 3) with the third temperature difference 72, in other words by the Boolean expression Δ∂_{r,H}≧Δ∂_{r,C}. In the twenty-first decision 104 the Boolean expression “the room temperature possibly exceeds the upper setpoint temperature value” is evaluated and if the expression is true, the eighth step 106 is performed, in which the operating state “mechanical-ventilation-night” is set to the operating state value “discharge-storage-unit”, otherwise the seventh step 105 is performed, in which the operating state “mechanical-ventilation-night” is set to the operating state value “charge-storage-unit”.

The output signal ventilate 13 is generated in the first facility 2 responsible for operating the mechanical ventilation in the room 8 as a function of the reference signal 31 which corresponds to the set operating state value of the operating state “mechanical-ventilation-night”.

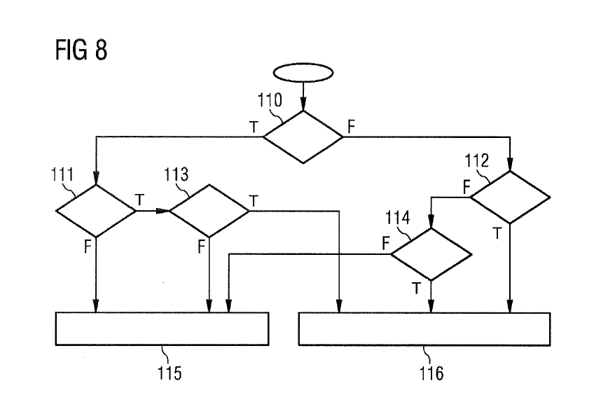

FIG. 8 shows a flow diagram to illustrate, for example, rules, according to which operating state values of the operating state “heat-recovery” of the third operation type 37 (FIG. 1) are defined and set for corresponding control of the air processing unit 40.

In a twenty-second decision 110 the Boolean expression “heating requirement determined in the time interval 73” is evaluated and if the expression is true, the method continues with a twenty-third decision 111, or otherwise with a twenty-fourth decision 112. In the twenty-third decision 111 the Boolean expression “cooling requirement determined in the time interval 73” is evaluated and if the expression is true, the method continues with a twenty-fifth decision 113, otherwise in a ninth step 115 the operating state “heat-recovery” is set to the operating state value “charge-storage-unit”. In the twenty-fifth decision 113 the Boolean expression “the last action was heating” is evaluated and if the expression is true, in a tenth step 116 the operating state “heat-recovery” is set to the operating state value “discharge-storage-unit”, otherwise the ninth step 115 is performed, in which the operating state “heat-recovery” is set to the operating state value “charge-storage-unit”. In the twenty-fourth decision 112 the Boolean expression “cooling requirement determined in the time interval 73” is evaluated and if the expression is true, the tenth step 116 is performed, in which the operating state “heat-recovery” is set to the operating state value “discharge-storage-unit”, otherwise the method continues with a twenty-sixth decision 114. In the twenty-sixth decision 114 the Boolean expression “the room temperature is high” is evaluated and if the expression is true, the tenth step 116 is performed, in which the operating state “heat-recovery” is set to the operating state value “discharge-storage-unit”, otherwise the ninth step 115 is performed, in which the operating state “heat-recovery” is set to the operating state value “charge-storage-unit”. An advantageous specific instance of the Boolean expression “the room temperature is high” is obtained by a comparison of the second temperature difference 71 (FIG. 3) with the third temperature difference 72, in other words by the Boolean expression Δ∂_{r,H}≧Δ∂_{r,C.}

Necessary adjustment signals are generated in the air processing unit 40 responsible for operating heat recovery in the room 8 as a function of the reference signal 33 corresponding to the set operating state value of the operating state “heat-recovery”.

The system also includes permanent or removable storage, such as magnetic and optical discs, RAM, ROM, etc. on which the process and data structures of the embodiments can be stored and distributed. The processes can also be distributed via, for example, downloading over a network such as the Internet. The system can output the results to a display device, printer, readily accessible memory or another computer on a network.

A description has been provided with particular reference to preferred embodiments thereof and examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

1. A method for controlling and regulating at least one room comfort variable in a building, comprising:
storing requirement signals for cost-intensive energy during a time interval comprising a specified time period, and
evaluating the requirement signals stored in the elapsed time interval and using the evaluated requirement signals to generate current control signals for actuators for use of free or low-cost energy.

2. The method as claimed in claim 1, further comprising evaluating data for the at least one room comfort variable stored in the elapsed time interval of the specified time period to generate said control signals.

3. The method as claimed in claim 1, further comprising selecting a setpoint room temperature value band bounded by a lower limit value and an upper limit value into which the room temperature is regulated.

4. The method as claimed in claim 3, wherein the limit values of the setpoint room temperature value band stored in the elapsed time interval are taken into account when generating the control signals.

5. The method as claimed in claim 1, wherein the room temperature values stored in the elapsed time interval are taken into account when generating the control signals.

6. The method as claimed in claim 4, wherein a difference between the room temperature values stored in the elapsed time interval and the limit values of the setpoint room temperature value band are defined when generating the control signals.

7. The method as claimed in claim 1, further comprising deciding, with aid of the requirement signals for cost-intensive energy stored in the elapsed time interval, whether the heating or cooling of a mass of the building, which acts as a thermal storage unit, is to be forced with free or low-cost energy.

8. The method as claimed in claim 1, further comprising determining and storing at least one operating state value i with the requirement signals stored in the elapsed time interval being evaluated to determine the operating state value and using the operating state values to generate current control signals for actuators for the use of free or low-cost energy.

9. The method as claimed in claim 1, further comprising determining at least two operating state values relating to venetian blinds associated with a venetian-blind-position.charge-storage-unit and a venetian blind-position.discharge-storage-unit, with an operating state value associated with the venetian blind-position.charge-storage-unit triggering the charging of the mass of the building acting as a thermal storage unit or an operating state value associated with the venetian blind-position.discharge-storage-unit) triggering the discharging of the mass of the building acting as a thermal storage unit, by evaluating a signal for a heat requirement stored in the elapsed time interval and a signal for a cold requirement stored in the elapsed time interval.

10. The method as claimed in claim 1, further comprising determining at least two operating state values associated with a free-cooling.charge-storage-unit and a free-cooling.discharge-storage-unit relating to low-cost cooling, with an operating state value associated with the free-cooling.charge-storage-unit triggering the charging of the mass of the building acting as a thermal storage unit or an operating state value associated with the free-cooling.discharge-storage-unit triggering the discharging of the mass of the building acting as a thermal storage unit, by evaluating a signal for a heat requirement stored in the elapsed time interval and a signal for a cold requirement stored in the elapsed time interval.

11. The method as claimed in claim 1, further comprising determining at least two operating state values associated with a natural-ventilation-night.charge-storage-unit and a natural-ventilation-night.discharge-storage-unit relating to natural ventilation in the night, with an operating state value associated with the natural-ventilation-night.charge-storage-unit triggering the charging of the mass of the building acting as a thermal storage unit or an operating state value associated with the natural-ventilation-night.discharge-storage-unit triggering the discharging of the mass of the building acting as a thermal storage unit, by evaluating a signal for a heat requirement stored in the elapsed time interval and a signal for a cold requirement stored in the elapsed time interval.

12. The method as claimed in claim 1, further comprising determining at least two operating state values associated with a mechanical-ventilation-night.charge-storage-unit and a mechanical-ventilation-night.discharge-storage-unit relating to mechanical ventilation in the night, with an operating state value associated with the mechanical-ventilation-night.charge-storage-unit triggering the charging of the mass of the building acting as a thermal storage unit or an operating state value associated with the mechanical-ventilation-night.discharge-storage-unit triggering the discharging of the mass of the building acting as a thermal storage unit, by evaluating a signal for a heat requirement stored in the elapsed time interval and a signal for a cold requirement stored in the elapsed time interval.

13. The method as claimed in claim 1, further comprising determining at least two operating state values associated with a heat-recovery.charge-storage-unit and a heat-recovery.discharge-storage-unit relating to heat recovery, with an operating state value associated with the heat-recovery.charge-storage-unit triggering the charging of the mass of the building acting as a thermal storage unit or an operating state value associated with the heat-recovery.discharge-storage-unit triggering the discharging of the mass of the building acting as a thermal storage unit, by evaluating a signal for a heat requirement stored in the elapsed time interval and a signal for a cold requirement stored in the elapsed time interval.

14. The method as claimed in claim 8, wherein when the operating state value is set it is also taken into account whether a room in the building is occupied.

15. The method as claimed in claim 1, wherein the time period of the elapsed time interval is between around 6 and 72 hours.

16. The method as claimed in claim 1, wherein the time period of the elapsed time interval is around 24 hours.

17. An system, comprising:
a hierarchical structure comprising at least two levels for controlling and regulating at least one room comfort variable in a building, having at least one facility disposed at an upper level for the optimizable control and regulation of the use of at least one low-cost or free energy source, and having at least one facility disposed at a lower level below the higher level for the lower-order regulation or control of the use of at least one further energy source, with a room comfort variable being the room temperature and the regulation strategy of the higher-order facility making use of attributes of a passive thermal storage unit of the building, it being possible instead of a setpoint room temperature value to select a setpoint room temperature value band bounded by a lower value and a higher value, into which the room temperature can be regulated; and
means for implementing a method as claimed in claim 1, and having a data flow from the lower level to the upper level and reference signals generated by the upper level and available in the lower level.

18. The system as claimed in claim 17, wherein a further room comfort variable is a brightness that can be controlled by electric lighting units and/or by sunlight that can be guided through windows.

19. The system as claimed in claim 17, wherein the low-cost or free energy source is radiation that can be guided into the building or out of the building by controllable permeability of windows and/or facades.

20. The system as claimed in claim 17, further comprising a facility disposed in the building for visualizing at least one operating state value of the system.
